(19) United States
(12) Patent Application Publication
(10) Pub. No.: US 2018/0293164 A1
(43) Pub. Date: Oct. 11, 2018

(54) AUTOMATIC PERSISTENT MEMORY MANAGEMENT

(71) Applicant: Hewlett-Packard Development Company, L.P., Houston, TX (US)

(72) Inventors: Taciano Dreckmann Perez, Porto Alegre (BR); Diego Rahn Medaglia, Porto Alegre (BR)

(21) Appl. No.: 15/749,078

(22) PCT Filed: Oct. 1, 2015
(86) PCT No.: PCT/US2015/053494

§ 371 Date: Jan. 30, 2018

(51) Int. Cl. G06F 12/02; G06F 9/455

(52) U.S. Cl. CPC G06F 12/0238; G06F 12/1416; G06F 9/45558; G06F 12/0253

(57) ABSTRACT

Examples disclosed herein relate to automatic persistent memory management. An example system includes a non-volatile memory to allocate space as persistent data space and a processor executing a program to generate program data to be stored as persistent data in the persistent data space. The example system can also include a memory manager to protect program data that is reachable from persistence roots from deallocation.

### BACKGROUND

Memory technology can include volatile and non-volatile memory. Volatile memory only maintains its data while the volatile memory is powered. Non-volatile memory can store and retrieve its data even after having been powered off and on. Recent developments in non-volatile memory technology may allow access to data in non-volatile memory at speeds approaching those of volatile memory. A computer or system using multiple types of memory can choose to use an abstraction layer to manage or host the execution of a program. The computer or system using multiple types of memory to manage or host the execution of a program can also choose to use a virtual machine in order to provide a program uniform access to these potentially varied type of memory.

### DESCRIPTION OF THE DRAWINGS

Certain exemplary embodiments are described in the following detailed description and in reference to the drawings, in which:

FIG. 1A is a block diagram of an example system for persistent memory management;

FIG. 1B is a block diagram of a simplified example system for persistent memory management;

FIG. 2 is a diagram of an example mapping of a program storing data as persistent data;

FIG. 3 is a flowchart of an example method for persistent memory management;

FIG. 4 is a block diagram of an example tangible, non-transitory, computer-readable medium including instructions to direct a processor to manage persistent memory; and

FIG. 5 is a block diagram of an example persistent class executing in a persistent heap.

### DETAILED DESCRIPTION

Virtual computer machines, such as a Java Virtual Machine, can include memory management techniques. As the technology of memory storage advances, so can the techniques and systems for managing data stored in computer memory. Data can be made persistent or kept for a long or undetermined period of time across different executions of a program. In systems without persistent, directly-addressable memory technologies, data can be given persistence through copying the data from a volatile memory into a storage medium, such as a hard disk or flash memory. From a software perspective, different data representations can be employed to store data in memory and storage. For example, data structures in memory can include trees, lists, maps, hash tables, objects, and other data structures. Data structures in the storage medium may include binary files, text files, and relational tables. In systems without persistent memory, making data persistent can include copying data from memory to storage, which, due to often differing data structures, can involve the extra action of a computer executing code specifically convert between data structures. This may slow execution due to the extra instructions used, and the time and resources used for copying data between locations. Further, the copying can increase the burden on programmers, as a result of the extra programming, debugging, and testing used for the code performing the data structure conversion.

The techniques disclosed in the present disclosure allow for an automatic persistence management based on the use of non-volatile memory. A programmer using automatic persistence management can avoid explicitly indicating when data can be stored or retrieved, since these operations are performed transparently by a persistent memory manager. In an example, data stored in persistent memory can be managed, modified, stored, and removed with the disclosed data lifecycle and memory management tools. The data lifecycle management and memory tools include several automatic persistence scenarios, including data persistence and execution persistence. These persistence scenarios can identify data in a persistent memory to persistently store.

For example, the persistent data of a machine implementing data persistence can include type definitions (e.g. classes) and a persistent heap containing elements like objects and variables. In a data persistence mode of the presently disclosed techniques, these elements may be stored in non-persistent memory or marked for deletion by a persistence manager, which may act in concert with a garbage collector process. A garbage collection process can receive an indication that data can be deleted, reallocated, or written over with newer relevant data, an in an example, the garbage collector process can execute those actions. In an example, a machine implementing execution persistence stores both data and the execution state and keeps all the above listed elements in persistent memory.

One example of a virtual computer machine is the Java Virtual Machine, which is a runtime environment that executes programs and applications using a set of bytecodes defined by the Java Virtual Machine specification. A process that runs on a Java Virtual Machine can be called a Java Virtual Machine process. As a virtual machine, the Java Virtual Machine can execute a number or programs including programs written in Java and other languages, such as Scala, Clojure, and other similar languages. Other examples of programming systems that may be used as the virtual computer machines of the present techniques are the Python interpreter, or the Python interpreter for the Java language.

During execution of a program on a virtual computer machine, objects, references, primitive types, interfaces and other data can be created and maintained in structures that reside in memory, such as volatile or non-volatile memory. An example of these data structures can include heap and stack data structures. Automatic persistence management allows the data structure to remain in persistent memory, removing the need to convert the data structure to other formats in order to be made persistent, and transparently managing the lifecycle of persistent data.

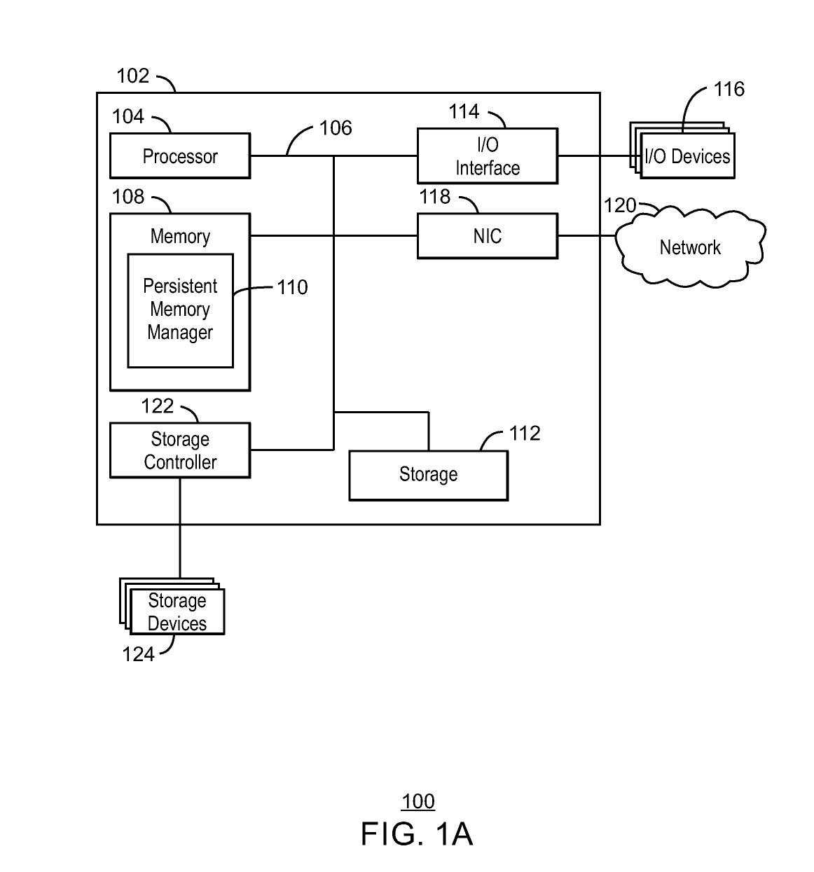

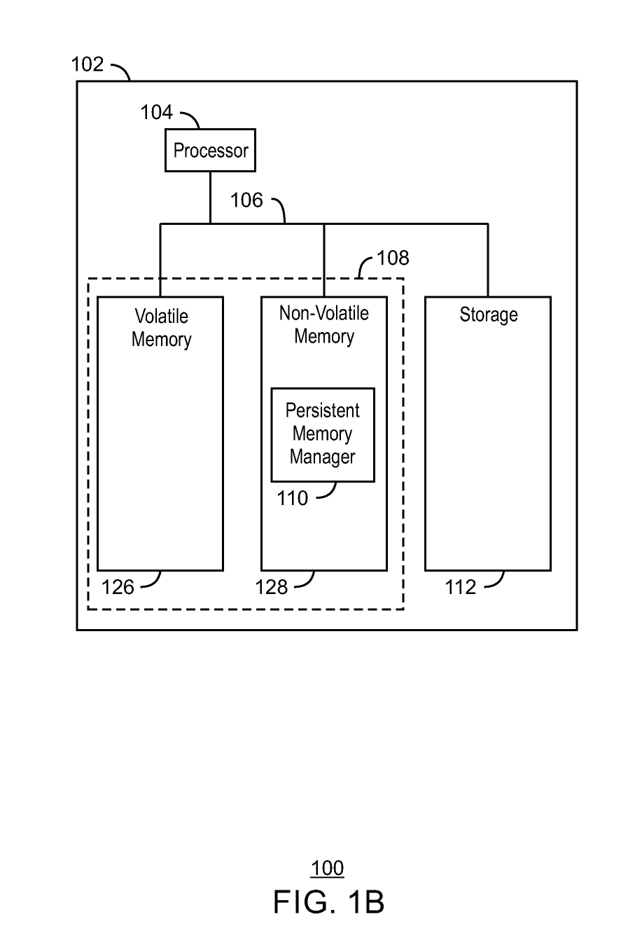

FIG. 1A is a block diagram of an example system 100 for automatic persistent memory management. The system 100 includes a computing device 102. The computing device can be a mobile phone, a tablet computer, a desktop computer, a business server, a blade server, a storage attached network (SAN), a network attached storage (NAS), and the like. The computing device 102 includes at least one processor 104. The processor can be a single core processor, a multicore processor, a processor cluster, and the like. The processor 104 can be coupled to other units through a bus 106. The bus 106 can include PCIe interconnects, PCIx, or any number of other suitable technologies for transmitting information.

The computing device 102 can be linked through the bus 106 to a memory 108. The system memory 108 can include random access memory (RAM), including volatile memory such as static random-access memory (SRAM) and dynamic random-access memory (DRAM). The system memory 108 can also include directly addressable non-volatile memory, such as resistive random-access memory (RRAM), phase-change memory (PCRAM), Memristor, Magnetoresistive random-access memory, (MRAM), Spin-transfer torque Random Access Memory (STTRAM), and any other suitable memory that can be used to provide computers with persistent memory. In an example, a memory can be used to implement persistent memory if it can be directly addressed by the processor at a byte or word granularity and has non-volatile properties.

The memory 108 can store a persistent memory manager 110 to manage persistent memory containing persistent data. The management of persistent memory can include allowing virtual computer machines to execute operations that store their data in persistent memory. The persistent memory manager 110 can also designate objects or elements from these operations that are to be kept and those that can be deallocated. Deallocating can include a direction for deletion of specific data or an element. In an example, deallocation serves as a counter point to an allocation of space to a program in memory 108. Deallocation can indicate to a process, such as a garbage collector process, that specific data may no longer be accessed by a process or active element and therefore can be deleted, reallocated, or written over with newer relevant data.

The computing device 102 can include a tangible, non-transitory, computer-readable storage media, such as a storage 112 for the long-term storage of data, including the operating system programs and user file data. The processor 104 may be coupled through the bus 106 to an I/O interface 114. The I/O interface 114 may be coupled to any suitable type of I/O devices 116, including input devices, such as a mouse, touch screen, keyboard, display, and the like. The I/O devices 116 may also be output devices such as a display monitors.

The computing device 102 can also include a network interface controller (NIC) 118, for connecting the computing device 102 to a network 120. In some examples, the network 120 can be an enterprise server network, a storage area network (SAN), a local area network (LAN), a wide-area network (WAN), or the Internet, for example.

The processor 104 can also be coupled to a storage controller 122, which may be coupled to one or more storage devices 124, such as a storage disk, a solid state drive, an array of storage disks, or a network attached storage appliance, among others. The presence of the storage devices 124 may allow the computing device 102 to function as a storage attached network (SAN) on the network.

The storage device 112 can include local storage in a hard disk or other non-volatile storage elements. While generally system information may be stored on the storage device 112, in this computing device 102, the program data can be stored in the memory 108 as indicated here and discussed further in FIG. 1B.

It is to be understood that the block diagram of FIG. 1 is not intended to indicate that the computing device 102 is to include all of the components shown in FIG. 1. Rather, the computing device 102 can include fewer or additional components not illustrated in FIG. 1. For example, the persistent memory manager 110 can be implemented as stored software in the storage 112 that can be initialized and loaded into memory 108 upon the booting of the system 100. In an example, if the computing device 102 is a server or blade server, the storage controller 122 and external storage devices 124 may not be present. In an example, the computing device 102 can include additional processors, memory controller devices, network interfaces, etc.

FIG. 1B is a block diagram of a simplified example system for persistent memory management. Like numbered items are as described in FIG. 1. The computing device 102 can include a memory 108 with a volatile memory 126 and a non-volatile memory 128. As discussed above, the persistent memory manager 110 can be located in the non-volatile memory 128. In an example, the location of a persistent memory manager 110 indicates the location of programs implementing persistent data storage. The location of the persistent memory manager 110 can also indicate a location where instructions for persistent memory management are held. Accordingly, the persistent memory manager 110 can also be located in storage 112, while instructing the management of persistent memory in the non-volatile memory 128.

In an example, the computing device 102 enabled with persistent memory manager 110 can have a bus 106 connection between the loads of the processor 104 and memory stores in the persistent memory. In an example, the processor 104 can have volatile CPU caches in addition to the direct access between the processor 104 and the persistent memory.

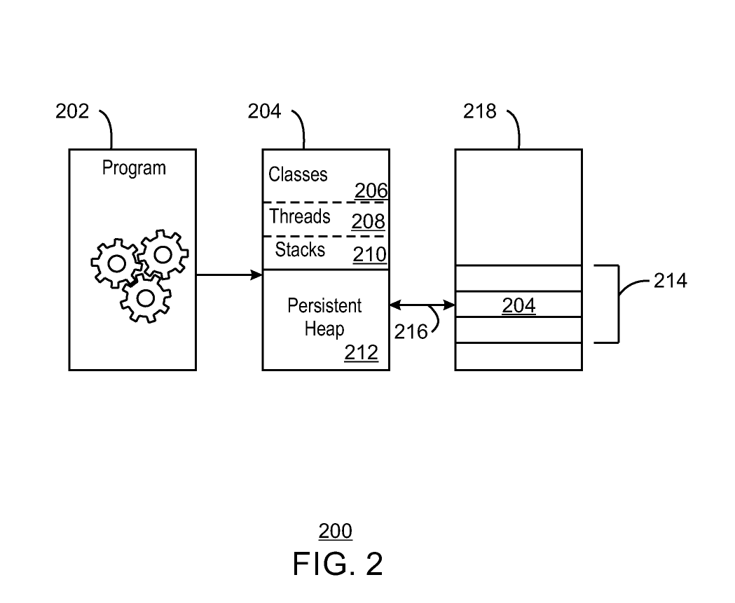

FIG. 2 is a diagram of an example mapping 200 of a program storing data as persistent data. Like numbered items are as described in FIG. 1. A computing device 102 can implement programs, processes, and can also implement a virtual computer machine that assists programs in their operation. In an example, a virtual computer machine can include a Java Virtual Machine to run a Java program or process.

A program 202 can be run on the computing device 102 with program data to be stored in as persistent data 204. Program data that can be stored as the persistent data 204 can include classes 206, threads 208, stacks 210, and heap 212. A class 206 can be generated as program data from the program 202 or can be loaded by the program 202 from instructions. A class 206 can be a template for creating objects for the program 202 or can be used by a virtual computer machine. A class 206 can provide initial values for a state of a program 202, a virtual computer machine, and can also implement functions for a program to interact with. A thread 208 can include data relevant to a line of execution by a program 202. In an example, multiple threads 208 can allow multiple paths of execution that can each access objects of program 202. A stack 210 can be a data structure to store information about subroutines of a program 202 or a virtual computer machine implementing a program 202. Similarly, a heap 212 can also refer to a data structure that stores information in a tree-based structure, allowing dynamic data allocation/deallocation during program execution. The heap 212 structure for data storage can be stored as part of the persistent data 204. In an example, when a virtual computer machine initializes on a computing device 102, an area of memory 108 can be set aside for the persistent data 204. Additional memory 108 can be allocated for a persistent data 204 depending on the operation of a program 202. Further, allocation of memory 108 space to persistent data 204 can be dynamic, in that the amount of memory can vary depending on the demands of the program 202 being executed. For example, larger amounts of memory can be allocated to a program 202 operating on larger amounts of data, and when the program 202 no longer finds this data useful, the data and data space can be deallocated. Data and data space in a memory heap that becomes deallocated when it is designated no longer as persistent data. Persistent data is spared from deletion subroutines, often referred to as garbage collection. In various examples, the designation of data or the memory space storing that data can be unprotected by default, with garbage collection of data not reachable by a root currently used by a program 202 determining which data can be deallocated. In an example, data and memory space dedicated to a program 202 or a virtual computer machine can also be explicitly designated for deletion or replacement by other program data. Through the process of deallocation, resources can be more efficiently allocated to programs 202 and virtual computer machines finding use for the resources. While FIG. 2 shows classes 206, threads 208, stacks 210, and heaps 212 as data to be stored as persistent data 204, other program data generated by or used for a program 202 or virtual computer machine can also be included in the persistent heap 204.

The persistent data 204 can be located in an in-memory file system 214 or can be mapped to the in-memory file system 214 by a system call 216 such as a mmap system call. An in-memory file system 214 can be an abstraction layer that a program 202 or virtual computer machine can interact with, rather than directly accessing a memory 108 in order to allow access to a number of memory modules or memory types in a uniform way for a program 202. The system call 216 mapping persistent data 204 to an in-memory file system can manage the access and updates of a program 202 to the in-memory file system 214.

The in-memory file system can be located on a persistent memory 218. As discussed above, persistent memory can be located on non-volatile memory 128 and can be an allocated space in memory 108 for data intended to exist beyond a single session of a program 202, virtual computer machine, or even beyond a single powered state of a computing device 102. In an example, a persistent memory 218 can allow the storage of program data, including the data of persistent data 204 as long as the data is not deallocated.

In an example the program 202 can have access to a portion of, or all of the persistent memory 218. As illustrated in FIG. 2, this can be achieved by using a file system, such as the in-memory file system 214 designed specifically for persistent memory 218. The in-memory file system 214 can provide direct access between a program and persistent memory resulting in improved performance over disk or flash-based systems. In an example, this improved performance can come from the direct access of persistent memory that removes the input/output layer intermediary, allows the bypassing of the page cache, and can remove other steps rendered unnecessary by this direct access.

When a virtual computer machine initializes for a program 202 to execute, the virtual computer machine can allocate or access at least a portion of the persistent memory 218 to contain persistent data. As discussed above, this portion of the persistent memory 218 can include persistent data 204. In some examples, the persistent data 204 of persistent memory 218 can include the heap 212, stacks 210, classes 206, threads 208, and any other suitable structures for the virtual computer machine. As discussed above, any data used by a program 202 executing on top of the virtual computer machine can reside inside the persistent data 204. As persistent data 204 can be directly stored in persistent memory 218, there may be no use in copying such data to other storage 112, nor to use or convert to a different data representation such as files or relational tables.

One example implementation of persistent data can include a memory-mapped file on top of a non-volatile memory aware file system, such as Persistent Memory File System (PMFS) or the Ext4 file system with DAX support. Persistent data 204 may be used by a single virtual computer machine, or can be used concurrently by one or more virtual computer machine processes at the same time. The persistent data 204 being used by more than one virtual computer machine can include a signature to be registered in persistent memory to identify program elements that reference a state outside of the persistent memory 218. In an example, the signature can be a tokens used for mutual exclusion by processes accessing the persistent data 204 and can include locks, semaphores, monitors and other similar tokens. The use of a signature can allow different virtual computer machine processes to coordinate concurrent access to the mutually shared persistent data 204.

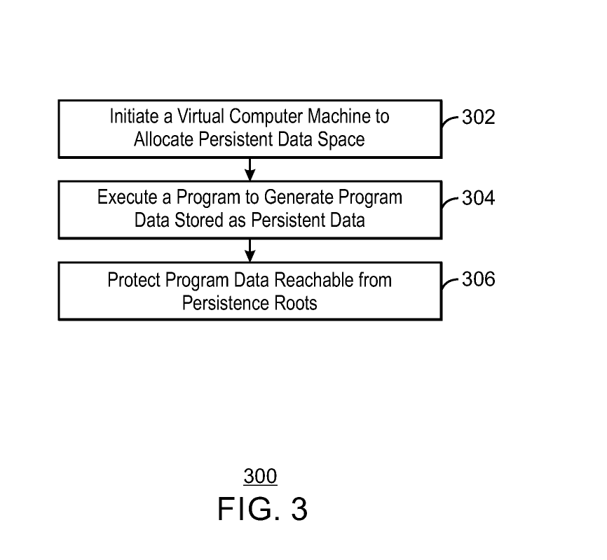

FIG. 3 is a flowchart of an example method 300 for persistent memory management. The example method begins at block 302, where a virtual computer machine is initiated. The virtual computer machine can be implemented on a computing device 102 of FIG. 1, or any other device with features similar to the processor 104 and persistent memory 218 described herein.

At block 302, a virtual computer machine initiates and allocates persistent data space. The virtual computer machine can initiate and allocate the persistent data space with a processor 104 or with a similarly suitable processing device. In an example, the virtual computer machine can allocate space in a non-volatile memory as persistent data space. Referring also to FIG. 2, the persistent data space can be a portion of persistent memory 218 or can include all of persistent memory 218 and can hold an in-memory file storage 214.

At block 304, a program can be executed to generate program data. The program can be executed on a virtual computer machine and can use a processor 104 to execute instructions stored in a memory 108 or in storage 112. In an example, the program data can be stored as persistent data 204 as discussed above. The program data can be generated by the execution of program by the virtual computer machine on the processor 104. The persistent data 204 can be stored in persistent data space including, for example, an in-memory file system 214 on a persistent memory 218 as described above.

At block 306, program data that is reachable from persistence roots can be considered persistent. Persistence roots may include class attributes, to provide data persistence, and also stack frame references, to provide execution persistence. Reachable program data can be data referenced or invoked by a program, class, object, thread, or other similar element that can reference data in a computing device 102. All persistent program data are not deallocated unless otherwise designated. In this example, a memory manager can keep program data persistent by not taking action to deallocate the program data as it may for other data.

In order to determine the lifecycle of how long program data can be kept in as persistent data before it can be deallocated, the memory management or garbage collection techniques of the persistent memory manager 110 can be used. As described above, deallocating program data can allow the space it occupies returns to the persistent data 204 available space and the processes accessing it. The persistent memory manager 110 can separate program data to be kept, from data that may be garbage collected by reachability criteria. Reachability can vary based on setting of a particular virtual computer machine implementation and can include elements that can be reached directly or indirectly from a set of persistence roots. In an example, elements that can be reached from a specified set of persistence roots can be kept while data that cannot be reached form these roots can be marked for disposal (e.g., garbage collection). In an example, class attributes can be the roots for a persistence mode called data persistence. In another example, stack frames can also serve as the roots for a persistence mode called execution persistence. In other examples, other elements or combinations of elements can serve as the persistence roots of a persistent memory manager 110.

In data persistence mode, the persistent memory manager 110 can store program data as persistent data 204, but may not store the program execution state. After a process execution is terminated or interrupted, all persistent data can be accessed as it is available in persistent memory 218 to be bound to a new process. In an example, this process can be the same or another program accessing the same data. In the data persistence mode, the persistent data 204 contains at least the type definitions, including classes, interfaces, method areas, and constant pools; objects such as type instances; and variables of primitive types. As discussed above, in the data persistence mode, objects reachable from class attributes can be considered persistent and can be spared by the persistent memory manager from disposal, while other data can be discarded or deallocated. When a program 202 with persistent data 204 in data persistence mode is executed, class definitions 206 that are already present as persistent data 204 can avoid being re-loaded, as their class attributes already may point to graphs of objects inside the persistent d 204.

In an execution persistence mode, the persistent memory manager 110 can store both program data and the execution state of a given program 202 as persistent data 204. If a virtual computer machine process terminates or interrupts, the persistent data 204 contains a snapshot of the execution state at a specific consistent point in time, and can be resumed from that point. In an example, a program data resumer can manage the resuming of the execution from this point. The program data resumer can prevent a processor that is resuming the execution of a program, from reloading program data protected by the memory manager during an execution interruption.

In execution persistence mode, the persistent data 204 contain at least elements stored for data persistence mode, plus stacks, threads, registers, program counters, and any other elements required to resume the execution in a future moment.

In execution persistence mode, objects that are reachable from either class attributes or stack frames can be considered persistent, and can be spared by the garbage collector. As stacks, threads, registers, program counters, and all other similar virtual computer machine internal data structures to control program execution can be stored inside the persistent data, execution may be resumed at any moment. When execution resumes, class definitions present on the persistent data can avoid being reloaded.

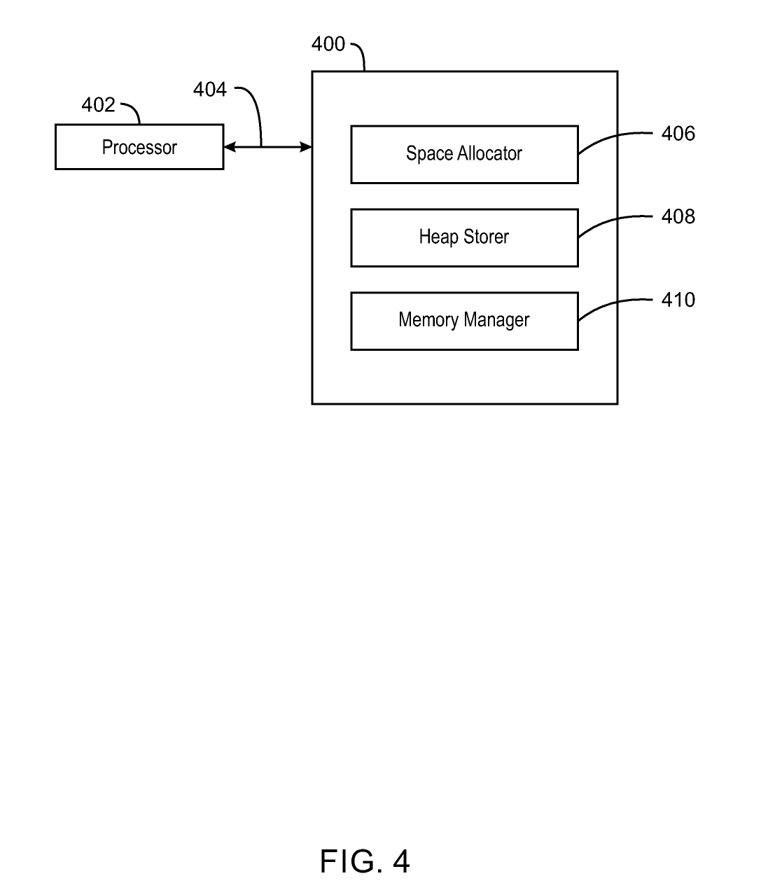

FIG. 4 is a block diagram of an example tangible, non-transitory, computer-readable medium 400 including instructions to direct a processor 402 to manage persistent memory. The computer readable medium can include the processor 402 to execute instructions received from the computer-readable medium 400. Instructions can be stored in the computer-readable medium 400. These instructions can direct the processor 402 to configure a device to manage persistent memory. Instructions can be communicated over a bus 404 as electrical signals, light signals, or any other suitable means of communication for transmission of data in a similar computing environment.

The computer-readable medium includes a space allocator 406, a heap storer 408 and a memory manager 410 each can store or provide instructions to the processor 402. The space allocator 406 can allocate space in a non-volatile memory 128 as persistent data space. As discussed with respect to FIG. 2, persistent data space can be persistent memory 218 or any other allocation of space for storing persistent data 204. The heap storer 408 can store program data as persistent data 204 in the persistent data space. In an example, the program data stored by the heap storer 408 can be program data generated by a program 202. The memory manager 410 can designate program data not reachable from a static variable as program data to be deallocated. In an example, the program data not reachable from a stack frame can also be designated for deallocation. As discussed above, the deallocation can be through a garbage collector erasing a space in memory or designating that space as available space for additional data use.

Some classes can handle state that is external to the virtual computer machine, such as files, sockets, and input/output devices in general. This external state can often be initialized during class loading, which in execution persistence mode may lead to problems when the execution resumes after interruption. In order to function properly in the execution persistence mode, classes may have to implement a class method with a known signature to be responsible for re-establishing consistency regarding external state. In an example, implementation can use these classes to implement a “static void classResume( )” method, and the registration of the class within the virtual computer machine using a special “PRuntime.addStaticListener(class)” class method created specifically for this purpose. When resuming execution, a virtual computer machine execution can invoke a classResume method for all classes previously registered.

In data persistence mode and execution persistence mode include sets of operations to be made atomically, in order to maintain consistency in the presence of unexpected execution failures or interruptions. For example, when a new object is created, a space is allocated in the heap, the object initializes, and a reference to the object can be placed at a stack frame or class attribute. In this example, the operations can be operations of atomicity in that either all operations can be completed or none are completed. The persistent manager can ensure that operations on persistent data 204 are each atomically executed through the use of a log area. This log area can contain a redo log, where all operations of atomicity are logged before execution, and may be replayed when the virtual computer machine resumes after an unexpected termination. The log area can alternatively use an undo log where the areas of the persistent data 204 to be touched by the atomic operations are logged before execution. In the undo log, the atomic operations can be rolled back when the virtual computer machine resumes after unexpected termination. In another example, the persistent manager can ensure atomicity by using copy-on-write techniques, i.e., whenever data is changed, a new copy is created inside the persistent data 204, and a reference to the old version of the data is atomically switched to point to the new copy of the persistent data.

In an example, a similar mechanism can be used to provide atomicity for operations of a program 202. For example, synchronized blocks and methods can have their atomicity enforced using log mechanism applied by the persistent data 204 a program 202 is executing on.

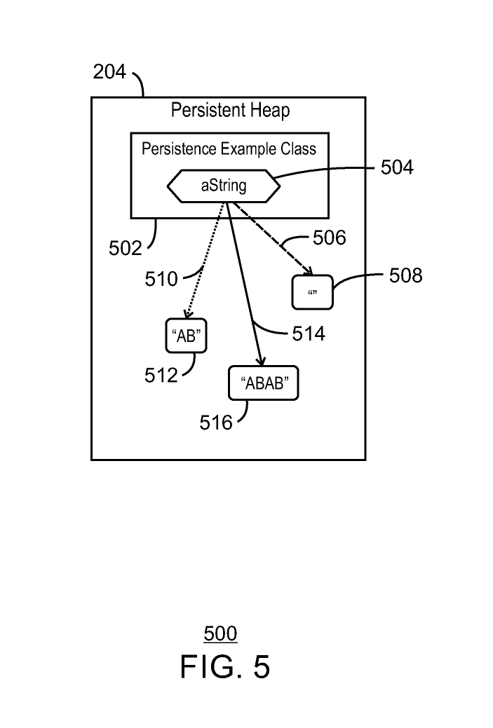

FIG. 5 is a block diagram of an example of persistent class 500 executing in persistent data 204. Like numbered items are as described in FIG. 1 and FIG. 2.

A persistent class 500 can be labeled as such for a processor 104 to properly assign a space in memory 108 and persistent memory 218. In an example, a persistent class operates from instructions stored in persistent memory 218 with all outputs also stored in persistent memory 218. In an example, the persistent data 204 can include instructions for classes, static variables and can store program data for an example short process shown here in Java-like pseudocode:

public class PersistenceExample {

private static String aString = ““;
public static void main(String[ ]args) {

aString += “AB”;
System.out.println(“aString=“+aString);
}

}

As shown in the pseudocode above, an example class 502 declares a class attribute, “aString” 504, initially pointing to Null 508. As shown in FIG. 5, and above in the pseudocode, the attribute aString is initialized as pointing to an empty string. When the method main( ) is executed for the first time 506, the initial value of aString 508 is concatenated to the string “AB” indicated in the above pseudocode, and thus aString 504 points to a new String object with the value “AB” in the persistent heap 212. In an example, when the program is executing on a Java Virtual Machine, new string objects are generated by every attribution, because strings are immutable objects in Java. If a program executes second time 514, it can create a third String object 516 with the value “ABAB” as, like above, the string “AB” was concatenated to the string object 512 created after a first execution 510. In an example, each of the String objects are in the persistent heap 212 as all program data is being stored in the persistent heap 212. However, in this example, the String object 516 contains the only object that can still be reached from the class attribute “aString” 504 to be kept in the persistent heap while it continues to be reachable. The previous string objects 508 and 512 can be deallocated by the persistent memory manager, as they were merely waypoints to the final string value and can be considered disposable.

While the present techniques may be susceptible to various modifications and alternative forms, the techniques discussed above have been shown only by way of example. It is to be understood that the technique is not intended to be limited to the particular examples disclosed herein. Indeed, the present techniques include all alternatives, modifications, and equivalents falling within the scope of the following claims.

What is claimed is:

1. A system for providing automatic persistent memory management, comprising:
a non-volatile memory to allocate space as a persistent data space;
a processor executing a program to generate program data to be stored as persistent data in the persistent data space; and
a persistent memory manager to protect program data that is reachable from persistence roots from deallocation.

2. The system of claim 1, wherein the program data includes type definitions, objects, and variables of primitive types.

3. The system of claim 1, wherein the persistent memory manager protects program data that is reachable from persistence roots comprising class attributes and stack frames.

4. The system of claim 3, wherein the program data includes type definitions, objects, variables of primitive types, stacks, threads, registers, and program counters.

5. The system of claim 1, wherein the program is a Java Virtual Machine process running on a Java Virtual Machine.

6. The system of claim 1, wherein the persistent data is a memory-mapped file on top of a non-volatile memory aware file system in persistent memory.

7. The system of claim 1, comprising a program data resumer to prevent the processor, which is resuming the execution of a program due to an execution interruption, from reloading program data protected by the persistent memory manager during the execution interruption.

8. The system of claim 7, wherein the program data resumer comprises a signature to be registered in persistent memory to identify program elements that references state outside of persistent memory.

9. The system of claim 1, wherein the persistent memory manager comprises a log area where the program stores operations of atomicity.

10. A method for providing automatic persistent memory management, comprising:
initiating, with a processor, a virtual computer machine to allocate space in a non-volatile memory as persistent data space;
executing a program with the virtual computer machine on the processor, where the program generates program data to be stored as persistent data in the persistent data space; and
protecting with a persistent memory manager, program data that is reachable from persistence roots from deallocation.

11. The method of claim 10, wherein the persistent memory manager protects program data that is reachable from the persistence roots (class attributes and stack frames.

12. The method of claim 11, wherein the persistent memory manager uses copy-on-write to execute operations on persistent data atomically.

13. The method of claim 10, wherein the persistent memory manager comprises a log area where the program stores operations of atomicity.

14. A tangible, non-transitory, computer-readable medium comprising instructions that, when executed by a processor, direct the processor to:
allocate space in a non-volatile memory as persistent data space;
generate program data to be stored as persistent data in the persistent data space; and
designate, with a memory manager, program data that is not reachable from persistence roots for deallocation.

15. The tangible, non-transitory, computer-readable medium of claim 14, wherein the memory manager additionally designates program data that is not reachable from persistence roots for deallocation.
